(19) United States
(12) Patent Application Publication
(10) Pub. No.: US 2024/0123446 A1
(43) Pub. Date: Apr. 18, 2024

(54) SINGLE CELL SENSING AND SELECTION

(71) Applicant: Hewlett-Packard Development Company, L.P., Spring, TX (US)

(72) Inventors: Alexander Govyadinov, Corvallis, OR (US); Viktor Shkolnikov, Palo Alto, CA (US)

(73) Assignee: Hewlett-Packard Development Company, L.P., Spring, TX (US)

(21) Appl. No.: 18/202,845

(22) Filed: May 26, 2023

Related U.S. Application Data
(63) Continuation-in-part of application No. PCT/US2022/046712, filed on Oct. 14, 2022.

(51) Int. Cl. B01L 3/00

(52) U.S. Cl. CPC B01L 3/502761; B01L 2200/025; B01L 2300/0829

(57) ABSTRACT

A microfluidic system may comprise a dispense head with multiple dispensers, each dispensing a different cell type, such as single pairs of individual target cells and individual sensor cells. Interaction between the cells may be observed based on, for example, fluorescence. Individual target cells may then be selected, based on observations, for use or for further investigation. As an example, target cells may be B-cells, and enhanced selection of B-cells aids more direct antibody discovery.

The present application is a continuation-in-part of and claims priority to PCT International Application No. PCT/US2022/046712, filed Oct. 14, 2022, which is incorporated by reference herein in its entirety.

### BACKGROUND

Microfluidic devices may include a channel through which a solution containing biological cells can flow. But detecting, selecting, and directing cells, especially on a single-cell basis, is challenging due to cell size and the potential of cells to aggregate.

### SUMMARY

Example implementations relate to a microfluidic system. The microfluidic system may comprise: a dispense head comprising: a first dispenser to dispense a first biological cell type and a second dispenser to dispense a second biological cell type; a first dispenser channel to load cells into a first cell staging chamber to be dispensed by the first dispenser, and a second dispenser channel to load cells into a second cell staging chamber to be dispensed by the second dispenser; and one or more sensing circuits to detect single cells in the first dispenser channel and in the second dispenser channel; and a controller to use the dispense head to dispense, in each individual well of a multiwell plate, an individual first cell from the first cell staging chamber and an individual second cell from the second dispenser cell staging chamber.

Other example implementations relate to a method comprising: using a dispense head to dispense, in each individual well of a multiwell plate, an individual first cell from a first cell staging chamber and an individual second cell from a second dispenser cell staging chamber such that the individual first cell and the individual second cell interact in the individual well, the dispense head comprising: a first dispenser to dispense a first biological cell type and a second dispenser to dispense a second biological cell type; a first dispenser channel to load cells into the first cell staging chamber to be dispensed by the first dispenser, and a second dispenser channel to load cells into the second cell staging chamber to be dispensed by the second dispenser; and one or more sensing circuits to detect single cells in the first dispenser channel and in the second dispenser channel.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 depicts a cell selection process flow according to various potential embodiments.

FIG. 2 depicts an example microfluidic system according to various potential embodiments.

FIG. 3 depicts an example integrated microfluidic system according to various potential embodiments.

FIG. 4 depicts interaction of example dispense heads and wells in a potential multiwell plate that allow for “salvo” operations according to various potential embodiments.

FIG. 5 depicts an example system with multiple staging chambers per dispense nozzle according to various potential embodiments.

FIG. 6 illustrates alignment of example multi-staging chamber dispensers with high density multiwell plates according to various potential embodiments.

FIG. 7 illustrates alignment of other example multi-staging chamber dispensers with high density multiwell plates according to various potential embodiments.

FIG. 8 illustrates an example nano-well plate according to various potential embodiments.

FIG. 9 depicts laser dispensing from an example composite multiwell plate according to various potential embodiments.

FIG. 10 illustrates another example nano-well plate according to various potential embodiments.

FIG. 11 depicts laser dispensing from another example composite multiwell plate according to various potential embodiments.

FIG. 12 depicts laser dispensing with an energy absorbing liquid according to various potential embodiments.

FIG. 13 depicts an example scanning laser setup according to various potential embodiments.

FIG. 14 depicts example cell detection electrodes according to various potential embodiments.

FIG. 15 depicts example staggered cell dispense elements for potential higher density multiwell plates according to various potential embodiments.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, may be arranged, substituted, combined, and designed in a wide variety of different configurations, all of which are explicitly contemplated and make part of this disclosure.

To evaluate the effectiveness of proteins or other target compounds produced by a target cell, the target cell may be allowed to interact with another cell that is affected by the target compound, and the interaction may be observed to evaluate the target cell and/or the target compound. Such other cells may be “sensor” cells (also referred to as “reporter” cells), and may be developed to have, for example, a model pathway that is to be modulated or otherwise affected by the target compound. The model pathway may be a therapeutic target for the target compound. For example, the model pathway may be a pathway that, in the sensor cell, modulates an enzyme that in turn can act on a substrate such as a fluorogenic substrate. Combining an indeterminate number of target cells with sensor cells may reveal that at least one of the target cells produces a target compound that affects the sensor cells, but that would not reveal which target cell is producing the effective compound. Even if every target cell in the indeterminate number were to produce a target compound that affects the sensor cells, one of the target cells may produce a version of the target compound that is more effective than the versions produced by other target cells, making it impossible to select the most desirable target cell. Example implementations of the disclosed approach pair different cell types in a single well, a single pair at a time. The paired cells may be incubated, and the effect of one cell on another cell can be determined. Target cells that are desirable for having a certain characteristic can then be selected. A selected or otherwise identified cell (e.g., a particular type of cell) in an individual well may then be produced (e.g., grown, multiplied, or otherwise used) and/or further characterized. The characteristic may be indicative of a particular cell that produces a desired product (e.g., a B-cell producing an antibody having an effect on a corresponding sensor cell in a selected individual well, such as a sensor cell with a druggable pathway of interest).

Example microfluidic systems disclosed herein can provide for efficient selection of cells. In a non-limiting example, the target cells may be B lymphocytes (also referred to as “B-cells”), and enhanced selection of B-cells aids more direct antibody discovery. In this example, the single pair of cells may be a single sensor cell and a single B-cell. B-cells are one of the main sources for antibodies for producing monoclonal antibodies, which are increasingly used as therapeutic agents. Production of monoclonal antibodies is expensive in part because of the difficulty in selecting B-cells that produce the most therapeutically effective antibodies. Example systems disclosed herein efficiently pair cells of a first type (e.g., B-cells) with cells of a second type that interact with the first type (e.g., sensor cells containing a druggable pathway of interest) in a well of a multi-well plate. Example systems disclosed herein enable selection of the droplet with the cell of the first type that has the strongest effect a cell of the second type (e.g., selection of the droplet containing the B-cell with the strongest effect on the sensor cell).

Example implementations of the disclosure provide a microfluidic system that may combine single cell impedance sensing with a fluid actuator to place a single pair of cells at a time into a well of a multiwell plate. In one example implementation, the fluid actuator is, or comprises, a thermal inkjet (TIJ) actuator. In various potential implementations, the fluid actuator may be, or may comprise, a piezoelectric inkjet (PIJ) actuator, and/or other actuation architectures. In some examples, a fluid actuator may be, or may comprise, an inertial pump that includes a thermal actuator having a heating element (e.g., a thermal resistor) that may be heated to cause a bubble to form in a fluid proximate the heating element. In such examples, a surface of a heating element (having a surface area) may be proximate to a surface of a fluid channel in which the heating element is disposed such that fluid in the fluid channel may thermally interact with the heating element. In some examples, the heating element may comprise a thermal resistor with at least one passivation layer disposed on a heating surface such that fluid to be heated may contact a topmost surface of the at least one passivation layer. Formation and subsequent collapse of such bubble may generate flow of the fluid. In other examples, the fluid actuator(s) forming an inertial pump may comprise piezo-membrane based actuators, electrostatic membrane actuators, mechanical/impact driven membrane actuators, magnetostrictive drive actuators, electrochemical actuators, external laser actuators (e.g., that form a bubble through vaporization of a portion of the fluid with a laser beam), other such microdevices, or any combination thereof. In some implementations, the fluid actuators may displace fluid through movement of a membrane (such as a piezo-electric membrane) that generates compressive and tensile fluid displacements to thereby cause inertial fluid flow.

Once in the multiwell plate, the desired cell can be selected, such as through fluorescence sorting and analysis. A cell may be selected, for example, for exhibiting a characteristic. Selection of a cell may be implemented through selection of an individual well based on a response to an analysis that indicates the individual well includes a cell that exhibits a particular characteristic (based on, e.g., certain fluorescence response). Cells can be grown and the effect of one cell on another cell (e.g., the effect of a B-cell's antibodies on the sensor cell) can be observed, and a target cell selected for further investigation and potential production of cell lines (e.g., hybridomas). Example implementations of the disclosed approach can thus ensure that, for example, precious B-cells are paired with a sensor cell and its antibody can be probed for its ability to modulate the druggable pathway of interest. As a result, the disclosed approach can more efficiently deliver cells and/or cell products with desired characteristics. Moreover, example systems can dispense the produced single cells into their own wells, for further growth, characterization (e.g., characterization of products of a single cell), and further selection. Efficient selection antibodies, for example, provides faster and less costly therapeutic agents (e.g., for monoclonal antibody therapies).

Example systems may comprise a dispense head, an XY stage, a cell incubator, a plate reader, and a liquid handling robot (used interchangeably with automated liquid handler) (e.g., a pipetting robot) or other robots and/or robotic components. The dispense head can comprise at least two dispensers and two reservoirs. Each dispenser may comprise a fluid actuator (such as, but not limited to, a TIJ actuator). In example implementations, the dispensers of a dispense head may all be the same type of fluid actuators, or a dispense head may comprise two or more different types of fluid actuators. The XY stage may carry a mutiwell plate. The dispensers may include electrodes and a sensing circuit that enable the dispenser to observe a single cell and dispense it into a unique well. The dispenser may also contain a staging area to hold the cell before dispensing. In some examples, the system may include, as part of the dispense head or otherwise, a dispenser (e.g., a third dispenser) to dispense to dispense one or more reagents into one or more individual wells. In some examples, the stage might be holding a multiwell plate and is movable by the controller. In example implementations, one of the dispensers is to dispense individual B-cells, while the other is to dispense reporter cells. The XY stage carrying a multiwell plate moves relative to the dispensers, allowing the dispenser to deposit a unique single B-cell into one well, followed by a single sensor cell into the same well. The multiwell plate may be a composite plate with a through-hole chamber array, and a separable floor to allow for the chambers to be easily emptied once cells of interest are identified. The floors may be coated with a low surface energy material such as polytetrafluoroethylene (PTFE). Optionally there may be another dispenser to dispense additional reagents, such as a fluorogenic substrate into the wells. In some implementations, there may be multiple dispensers for dispensing different types of sensor cells, each with a different engineered pathway.

In operation, example implementations may first position the dispenser above a junk well. Nozzle resistors may fire until, for all dispenser channels, the cells are loaded into the cell staging chamber, ready to be dispensed. This may be done by detecting the position of the cell via sensing electrodes. Once all of the staging chambers are full for both cell types, the dispense head may move to the appropriate region of the well array and dispense the cells in a salvo (e.g., all at once). This may be done to compensate for the fact that moving the stage relative to the dispense head is slow relative to moving cells in the dispense head (e.g., orders of magnitude faster). In example implementations, this mode of operation allows for a large number of cells to be dispensed in a relatively short time. This process is then repeated to reload the staging chambers for the next salvo.

In example implementations, the first dispenser places a single target cell (e.g., a single B-cell) into a well, and the stage moves so that the second dispenser places a single sensor cell into the same well. This is repeated with a new well until a desired number of wells are filled. This may be repeated for several more plates, until a desired number of target cells is packaged into the plate (e.g., ˜10,000 to 1,000,000). The plate may then be moved to a cell incubator (e.g., a mammalian cell incubator). An incubator may be a device that provides conditions to encourage or facilitate growth and/or maintenance of cell cultures. The incubator may control and regulate such ambient conditions as temperature, humidity, gas composition of the atmospheric in a chamber in which cells are positioned (e.g., carbon dioxide, oxygen, and/or nitrogen content), ventilation, etc. An adjustable heater, for example, may be used to bring temperatures to 60 to 65° C. (140 to 150° F.), or potentially as high as 100° C. A commonly-used temperature for mammalian cells is approximately 37° C. (99° F.), as such a temperature promotes growth of the cells. Some incubators may have the ability to lower temperatures (e.g., via refrigeration or ventilation). In some implementations, the plate may be moved to the cell incubator by a plate handling robot. The cells in the multiwell plates may be cultured for, for example, 2 to 72 hours to allow the target cells to produce a product of interest (e.g., antibodies or target compounds), and allowing the product to modulate the sensing pathways of, or otherwise affect, the sensor cells. In some implementations, the sensor cells produce a fluorescent signal indicative of whether the pathway was modulated. To observe this signal, the plates may be placed into a plate reader (e.g., manually, or in an automated fashion with, e.g., a plate handling robot). The plate reader might detect signals from the individual wells of the multiwell plate a predetermined time after dispensing cells into the multiwell plate.

Once the fluorescent signal is read, and the desired wells identified (e.g., wells with cells in which the antibodies modulate the pathway to increase fluorescence), the plate may be moved to a liquid handling robot, so that the cells from the wells are aspirated and placed into a separate well plate holding target cells of interest.

The disclosed approach enables selecting target cells with high throughput and higher target cell utilization, as target cells are strictly paired with sensor cells, not indiscriminately paired. The disclosed approach increases the probability of more clinically relevant target cell identifications useful in, for example, antibody—antigen binding screening. More target cells are selected per target cell input, producing a larger variety of products from which to select, which can result in finding, for example, an antibody with larger specificity and sensitivity. Example implementations are a non-droplet based system, which has less requirement for optimization of continuous phase oil and surfactant. Example implementations can also provide integrated single cell dispensers, such that each target cell can be dispensed into its own well for further characterization and selection.

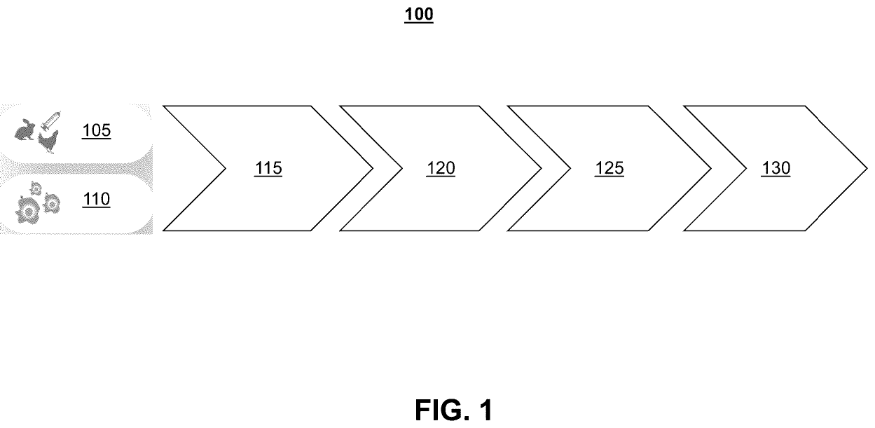

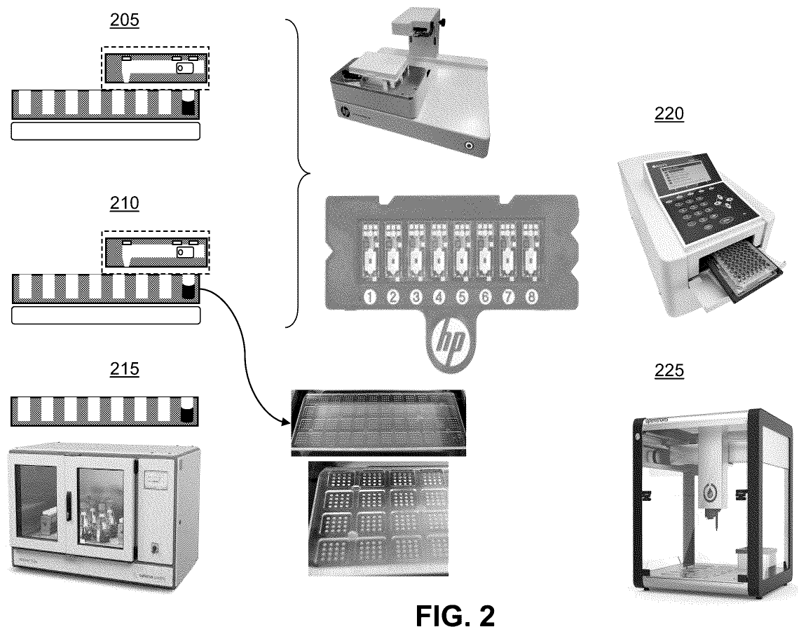

Referring to FIG. 1, an overview of an example target cell selection process flow is illustrated. In an example process flow, target cells to be investigated are obtained (105), such as by immunizing an animal to obtain B-cells that generate antibodies, and sensor cell lines are generated (110). A target cell may be a cell that is sought for causing a desired effect or result. A sensor cell may be a cell that, when proximate to the target cell, demonstrates or is otherwise indicative of whether, and/or to what extent, the target cell is achieving the desired effect or result. The target cells and sensor cells are individually paired (115), and the paired cells may be incubated (120) to facilitate their interaction. Following incubation, cells may be optically sorted (125) based on whether (and/or to what extent) the desired effect or result was observed. The effect or result may be detected optically using one or more optical sensors, or in other ways. Optical detection may be or may comprise detection of fluorescent light. In other examples, a distinct color and/or light scattering response may be detected. Cells appearing to exhibit desired properties (whether optically or otherwise) may be sequenced or otherwise further investigated and characterized (130). Referring to FIG. 2, an overview of an example system is depicted. Individual sensor cells may be dispensed, one cell at a time using a first dispenser (205), and target cells may be dispensed, one cell per well, using a second dispenser (210). The dispensers may be part of, for example, a cell dispenser (230). The cells may then be cultured in an incubator (215), and cells of interest identified based on, for example, optical characteristics or responses (e.g., fluorescence) in wells of interest using, for example, a gel scanner or plate reader (220). Cells may be pulled using a liquid handling robot for further use (225). Liquid handling robots may be automated liquid handlers of, for example, Hamilton Company, Tecan Trading AG, and/or Beckman Coulter, Inc. In some examples, a liquid handling robot moves the multiwell plate to at least one of a cell incubator or a plate reader. The liquid handling robot can move the multiwell plate to at least one of a cell incubator or a plate reader. The liquid handling robot may receive commands from the same controller that is controlling the dispenser or from a different controller.

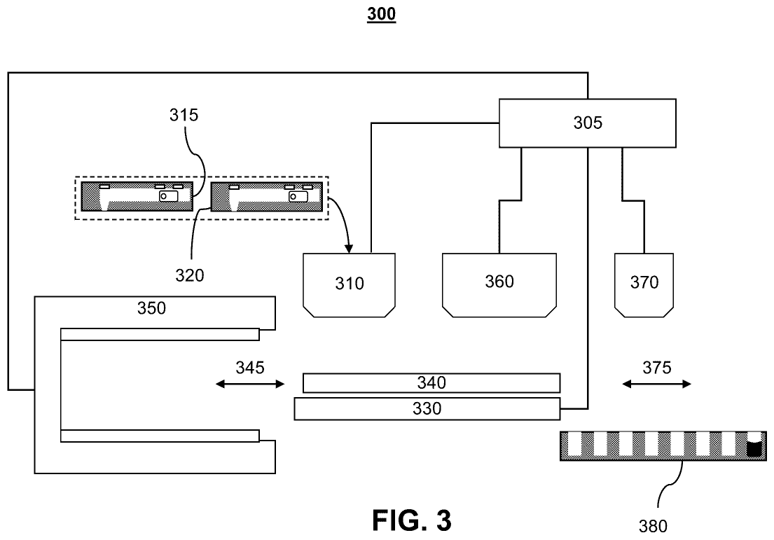

FIG. 3 illustrates an example integrated system according to potential implementations. In operation, the dispenser head (310) with at least two dispensing elements (315 and 320, for target cells and sensors cells, respectively) stages a multitude of each type of cell (e.g. 20 for a 20 nozzle dispenser). The XY stage (330) aligns the wells of the high density (e.g., nano-plate or micro-plate) multiwell plate (340) under the first dispensing element (e.g., 315), with the wells of the plate (340) aligned with the nozzles. The dispensing element then fires a salvo of cells simultaneously into the well plate. The XY stage (330) then moves the plate (340) under the second dispense head (e.g., 320) and fires the next salvo. The XY stage (330) then returns to a default position exposing a junk well to the dispensers and allowing the dispensers to refill the staging areas with the cells and prepare for the next salvo. This process then repeats until the high density multiwell plate (340) is filled with cells (e.g., 10,000 to 10,000,000 cells). The XY stage (330) then moves (345) the well plate (340) into a cell incubator (350) which provides, for example, 37 degrees Celsius (C) temperature control (or other temperatures as suited to the specific cells), and 5% carbon dioxide (CO₂). The cells may be incubated for a sufficient time to produce antibodies or other target compounds, and to allow the antibodies to bind to the sensor cells, as well as to allow the sensor cells to produce a fluorescence response. At this point the XY stage moves (345) the multiwell plate (340) from the incubator (350) and under fluorescence imaging optics (360). Using fluorescence imaging, a fluorescence response of the sensor cells is observed and wells with desired target cells are identified. The high density well plate (340) is then moved (375) under the well plate dispensing element (370). In some implementations, the bottom of the well plate is removed. The well plate dispensing element (370) may, for example, be or comprise a laser, an air jet nozzle, or a dispenser dispensing surfactant. In one example, the well plate dispensing element (370) further comprises a laser. The operation of laser-based dispensers is further described below. For an air jet nozzle, the nozzle blows a jet of air into well of interest of the high density well array (340), forcing the liquid from the well to fall into a designated well of a multiwell receiver plate (380) positioned below. For the surfactant dispenser (e.g., TIJ die loaded with a solution with a high concentration of surfactant), the surfactant solution is dispensed into the designated well of the high density multiwell plate (340). Example surfactants may include, for example, Pluronic® F68, Pluronic® F127, PEG 8,000 and/or PEG 20,000. This causes the surface tension holding the liquid at the bottom of the well to decrease, and the liquid is no longer held in the well. The liquid then falls into the designated well of the multiwell receiver plate (380).

Various operations as disclosed herein may be performed by a controller 305 of the system. The controller 305 may be a feedback controller and may include or be associated with one or more processing units or processors and one or more memories. The processing unit(s) may include a microprocessor, programmable logic controller (PLC) chip, an application specific integrated circuit (ASIC), one or more field programmable gate arrays (FPGAs), a digital signal processor (DSP), a group of processing components, or other suitable electronic processing components. The processing unit(s) of the controller 305 may be configured to execute computer-readable instructions for performing the operations described herein. The processing unit(s) may be implemented in hardware, firmware, software, or any combination thereof. “Executing a computer-readable instruction” means that the processing unit(s) may perform operation(s) called for by that instruction. The processing unit(s) may retrieve the instruction from a memory associated with the controller 305 for execution and copy the instruction in an executable form to a physical memory. In some embodiments, the processing unit(s) may be configured to execute the instruction without first copying the instruction to the physical memory. The instruction may be written using one or more programming languages, scripting languages, assembly languages, etc. Thus, the controller 305, via its associated processing unit(s), may be configured to execute instructions, algorithms, commands, or programs stored in the memory associated with the controller 305. In some examples, the controller 305 may be electrically and/or communicably coupled (such that, e.g., control signals may transmitted to systems or devices as commands to perform certain operations, and inputs may be received from the systems or devices) to the dispenser 310 (and/or to dispensing elements 315 and 320), to imaging optics 370 or other imagers or readers, to one or more well plate dispensing elements 370 (e.g., one or more lasers), to the XY stage 330, and/or to incubator 350, and may be configured to provide signals that activate or deactivate systems or devices and functionalities thereof. In some examples, the controller 305 may also be connected to other components, directly or indirectly, such as sensing electrodes or various circuitry to control operation of those components. One or more of the functions can be performed by, via, or with the help of one or more robots, which may be under the control of controller 305, or another controller that communicates with controller 305. In various examples, multiple controllers may cooperate to implement the operations discussed herein. In some examples, the controller can move the multiwell plate to a cell incubator after dispensing cells into the individual wells of the multiwell plate. In some other examples, the controller can further move the multiwell plate to a plate reader after moving the multiwell plate to the cell incubator. In some examples, the controller can identify one of the individual wells in the multiwell plate for holding cells exhibiting a characteristic, and dispensing contents of the identified individual well into a multiwell receiver plate. The controller may isolate a cell that exhibits one or more characteristics (e.g., characteristics associated with a cell of a certain type) and perform a production or characterization step on the isolated cell. The characteristic may, for example, be indicative of a B-cell producing an antibody having an effect on a corresponding sensor cell in the selected individual well. Once cell of a first biological type may be, for example, a B-cell, and the another cell of a second biological type may be, for example, a sensor cell with a druggable pathway of interest. The controller might also use a well plate dispensing element to dispense the contents of the identified individual well into the multiwell receiver plate. The well plate dispensing element can comprise at least one of a laser, an air jet nozzle, or a surfactant dispenser.

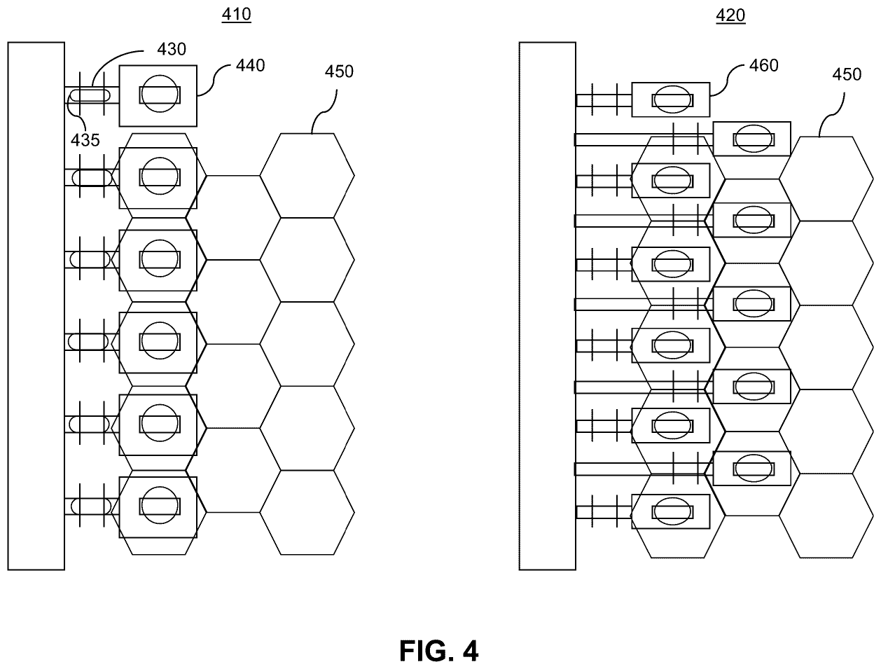

FIG. 4 illustrates interaction of dispense heads and wells in a multiwell plate suited to salvo operations according to example implementations. A standard nozzle density is depicted at 410, and a double nozzle density, with a staggered arrangement, is depicted at 420. At 410, a cell 435 is positioned at a cell staging area 430 prior to reaching nozzle 440. A high-density multiwell plate 450 is illustrated, with a multiwell array that includes wells on the same pitch as the dispense heads (e.g., about 80 μm (used interchangeably with microns or micrometers)). At 420, staggering of nozzles 460 provide nozzles over more wells at a time.

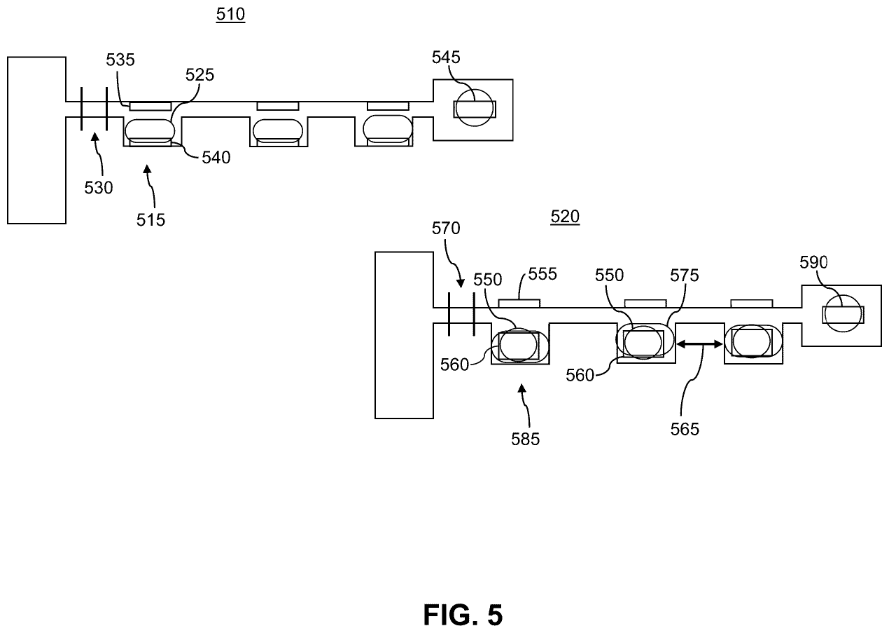

Referring to FIG. 5, an example arrangement with multiple staging chambers per dispense nozzle is illustrated. At 510, staging of cells in side chambers 515 is depicted, and at 520, staging of cells in ejection chambers 585 is illustrated. At 510, cell 525 is positioned downstream of sensing electrodes 530, between input resistor 535 and output resistor 540, and upstream of dispense resistor 545. At 520, cells 575 are positioned at nozzles 550 (depicted by the circles) of the side chambers 515, between input resistors 555 and output resistors 560. At 520, pitch is matched to the pitch of wells in the receiving high-density multiwell plate.

Referring to 510, the cell 525 incoming into the channel is sensed by the pair of impedance sensing electrodes 530. Once the cell's position is detected, a pre-calibrated number of firing events are actuated on the distal dispense resistor 545 to get the cell 525 into a position above each of the side chambers 515. Then the resistor for the chamber 515 into which the cell is to be placed fires, placing the cell 525 into a chamber 515. Once the cells are loaded in all of the chambers 525, this branch becomes inactive, waiting for the dispense resistor 545 to be aligned over the receiving high density multiwell plate. Once over the well plate, the output resistor 540 of each chamber 515 fires, pushing the cell 525 into the main channel. Then the dispense resistor 545 fires a prescribed number of times to dispense the cell 525 into the multiwell plate. The dispenser then is moved over one row relative to the multiwell plate. This operation is then repeated for the next side chamber 515 until all of the side chambers 515 are exhausted. Staging the cells 525 in this way minimizes or otherwise reduces the time it takes to dispense the cells 525 and so maximizes or otherwise increases the number of cells 525 that can be dispensed in a given amount of time. In some implementations, there can be sensing electrodes between the side chambers to provide more certainty as to the position of the cell and reduce the errors of loading of cells into the chamber.

At 520, the cell 575 incoming into the channel is sensed by the pair of impedance sensing electrodes 570. Once the cell's position is detected, a pre-calibrated number of firing events are actuated on the distal dispense resistor 590 to get the cell 575 into a position above each of the side chambers 585. Then the output resistor 560 for the chamber in which the cell is to be placed fires, placing the cell 575 into a chamber 585. Once the cells are loaded in all of the chambers 585, this branch becomes inactive, waiting for the dispense resistor 590 to be aligned over the receiving high density multiwell plate. Once over the well plate, the dispense resistor 590 in each of the chambers 585 fires, dispensing a 2D volley of cells into the receiving high density multiwell plate below.

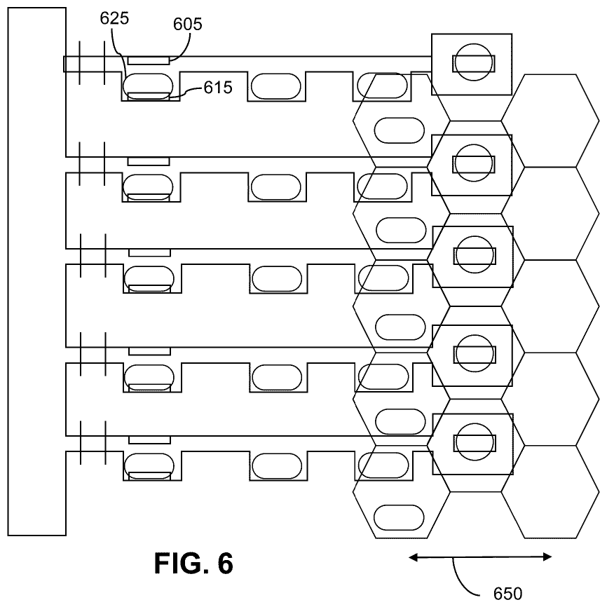

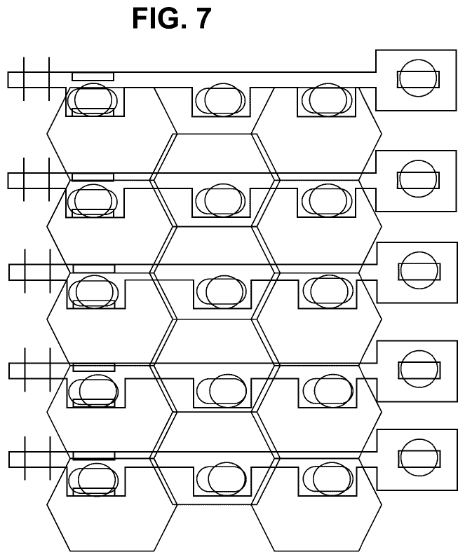

FIGS. 6 and 7 depict alignment of multi-staging chamber dispensers with high density multiwell plates according to example implementations. In FIG. 6, cells 625 are staged in side chambers between input resistors 605 and output resistors 615, with rapid motion 650 of the array under dispense heads. FIG. 7 depicts staging of cells in ejection chambers.

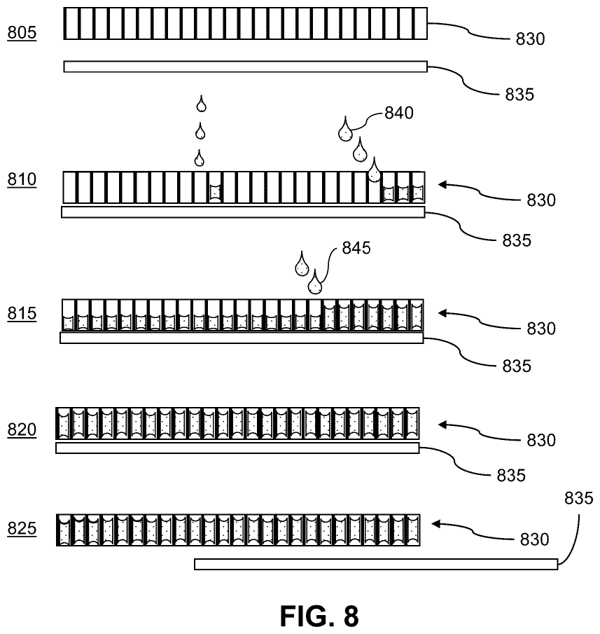

FIG. 8 depicts an alternative nano-well plate design according to example implementations. At 805, 20-100 μm open microcapillary wells 830 are depicted, with 2:1-5:1 aspect ratios and a hydrophilic internal surface. At 835, a hydrophobic nano-well plate holder (e.g., PTFE) 15 depicted. At 810, the nano-well plate and plate holder are brought in contact. A small gap may be left between the wells and the plate holder to prevent droplet suck-out at step 825. Drops 840 with cells of interest may be dispensed into wells. The drops 840 may be, for example, B-cells and buffer; in various implementations, 1-1000 droplets may be dispensed, depending on nano-well and droplet volumes. At 815, all wells are filled with the cells of interest. Capillary force will retain the fluid inside the capillary well. Sensor cells drops 845 are dispensed into the wells to obtain a filled wells at 820. At 825, the nano-well 830 is separated from holder plate 835 for transfer to a cell incubator. Oil isolation can be used also to protect from evaporation.

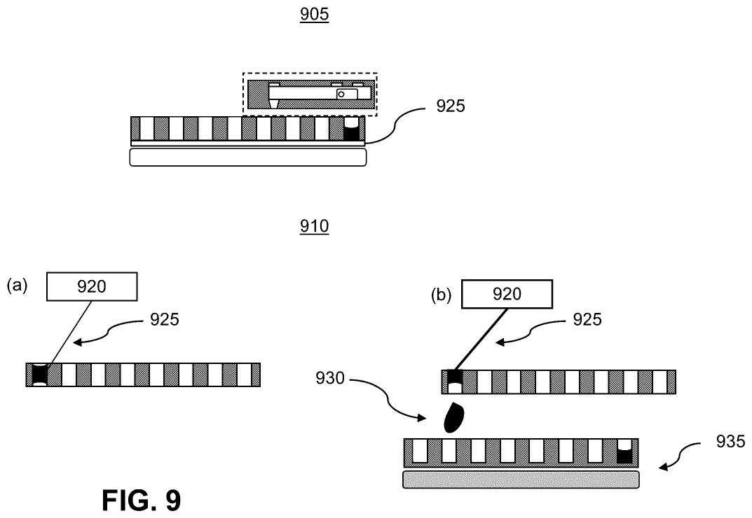

FIG. 9 depicts laser dispensing from the multiwell plate according to potential implementations. At 905, cells are dispensed into a well array with opening facing the dispenser (up). At 910, a detachable PTFE bottom 925 is detached to expose the bottom meniscus in order to dispense cells of interest from the array. In this case, a scanning laser 920 shines a beam 925 at the bottom meniscus. Upon absorption of light, the meniscus surface tension decreases, and the droplet 930, no longer held by surface tension in the array, falls by gravity into another, receiving multiwell plate 935.

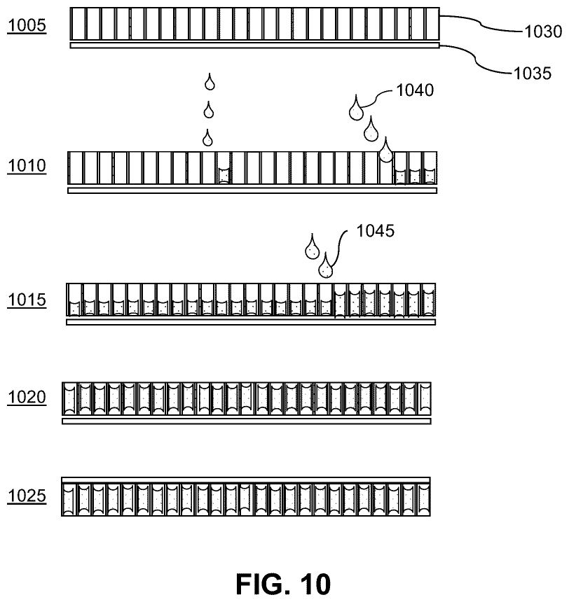

FIG. 10 depicts an alternative nano-well plate design according to potential implementations. At 1005, nano-well plate 1030 may have microcapillary wells that are 20 to 100 μm with an aspect ratio of 2:1 to 5:1. A hydrophobic nano-well plate holder 1035 (e.g., PTFE) may be positioned below the nano-well plate 1030. At 1010, the nano-well plate 1030 and the nano-well plate holder 1035 are brought into contact. A small gap between the nano-well plate 1030 and the nano-well plate holder 1035 helps prevent droplet suck-out at step 1025. Drops 1040 with cells of interest may be dispensed into wells (e.g., B-cells and buffer, 1 to 1000 droplets, depends on nano-well and droplet volumes). Capillary force will retain the fluid inside the capillary well. At 1015, drops 1045 with sensor cells can be dispensed into the nano-wells to obtain a full nano-well plate 1030 at step 1020. At 1025, the nano-well plate 1030 is separated from the nano-well holder plate 1035 and the nano-well plate 1030 is transferred to a cell incubator. Oil isolation can be used also to protect from evaporation.

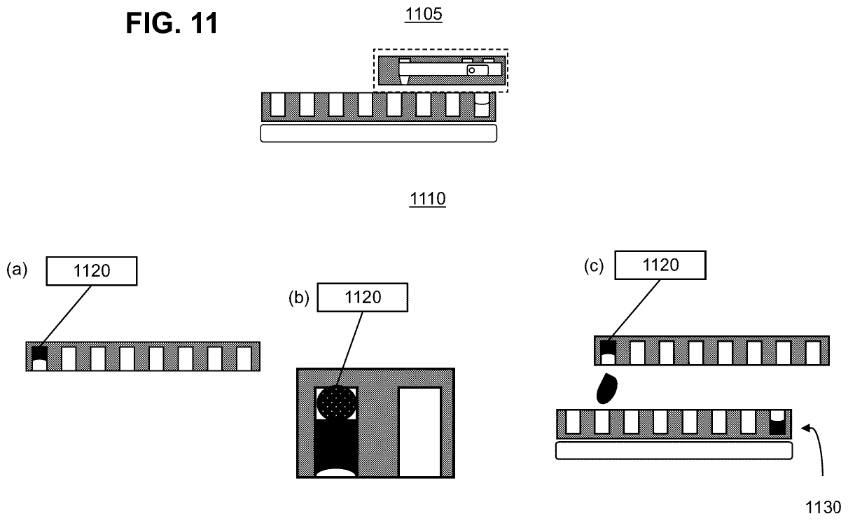

FIG. 11 depicts an alternative laser dispensing from multiwell plate approach according to potential implementations. At 1105, cells are dispensed into an array with an opening that faces the dispenser (up). At 1110, the array is flipped upside down to dispense cells of interest from the array. In this case, a scanning laser 1120 shines a beam at the bottom of the array. In certain implementations, the surface may be coated with a material that preferentially absorbs laser radiation of wavelength of interest (e.g., 785 nanometers (nm)). The material can also be a roughened metal surface (e.g., gold) to produce plasmonic absorption. Upon absorption of light, a vapor bubble at the bottom of the chamber forms, as the small portion of liquid (thin region of the bottom of the well) boils. This bubble expands, and forces the liquid in the well out, and into another, receiving multiwell plate 1130.

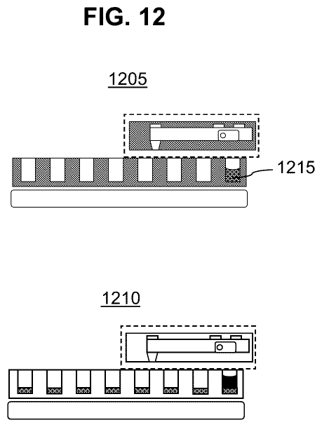

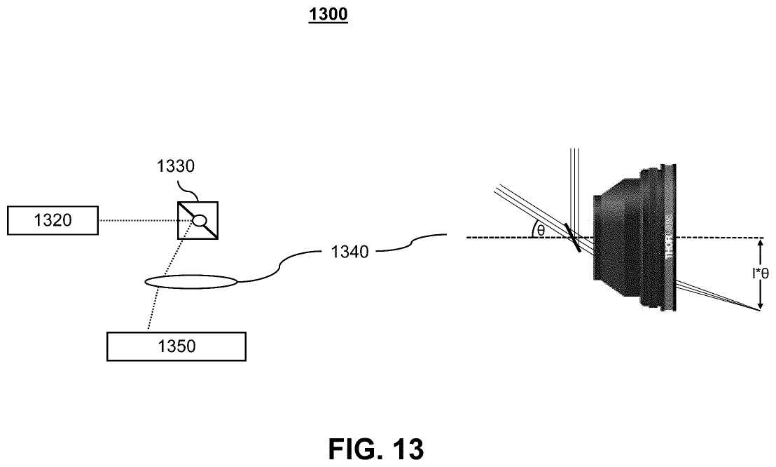

FIG. 12 depicts a laser dispensing from multiwell plate according to potential embodiments. At 1205, an energy absorbing liquid 1215 is dispensed into the bottom of the wells. The energy absorbing liquid may be, for example, silicon oil or FC-40 loaded with carbon particles. At 1210, cells of interest and sensor cells are dispensed into the array with opening facing the dispenser (up). FIG. 13 depicts a scanning laser setup 1300 according to potential implementations. A laser 1320 may emit a laser beam at well plate 1350 via a galvo mirror 1330 and F-theta lens 1340.

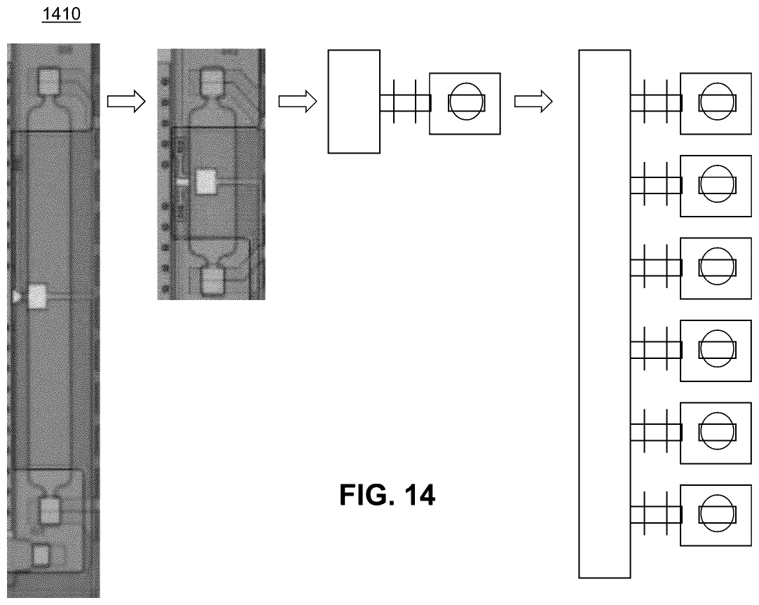

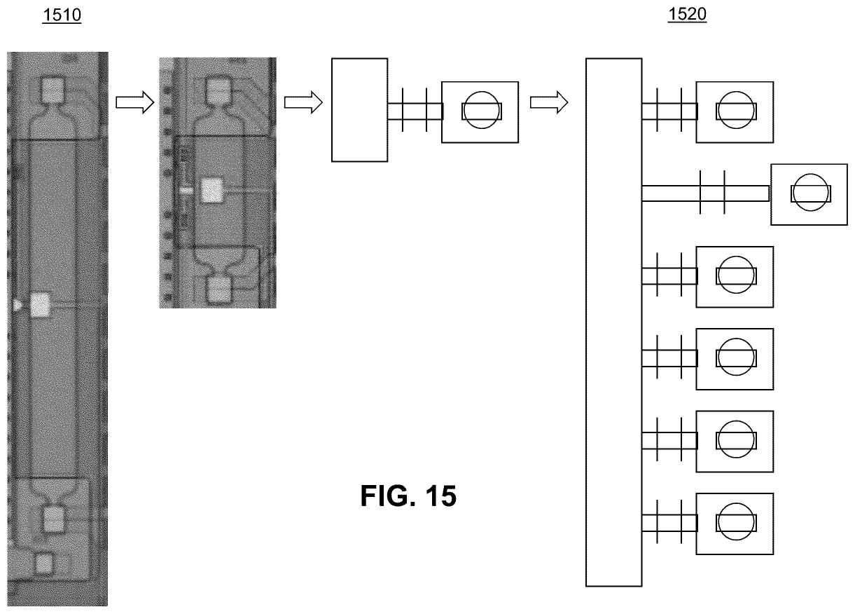

FIG. 14 depicts cell detection electrodes according to potential implementations. Impedance monitoring of the liquid with approximately a 1 microsecond (μs) sampling rate (e.g., approximately 50 measurements per firing to cover complete refill) is depicted. If a cell is detected (e.g., via single cell impedance sensing capability), the device may stop firing. In example implementations, the device has a controller, which directs the resistors to fire. The controller interfaces with the impedance sensors to measure whether the cell is present and control the resistor accordingly. In such examples, the controller stops firing the resistor when the cell is in correct position, because firing the resistor moves the fluid to move the cell. Multiplexing is on switching between firing nozzle. In example implementations, when there are multiple sensors, the multiplexing circuit may sense one set, then switch to another set, and to another set, in rapid succession. This can be accomplished provided that the sensing time (and switching time) is shorter than the time for the cell to move. Such an approach saves on the number of sensing lines moving from the die, and the amount of input/output (I/O) lines out of the die. As the number of sensing regions increases, the number of I/O lines could otherwise become impractical. Sensing multiplexing is synchronized with a drop ejecting nozzle. A pinch voltage may be greater than a 1.5 volt drop in potential examples. In the example geometry illustrated (e.g., electrode spacing and area illustrated), there is a tradeoff between lower voltages, which can reduce sensitivity, and higher voltages, which may damage cells. In various implementations, voltages from 0.1 V to 20 V may be suitable. At 1410, a single-cell dispensehead variant is illustrated. Such a variant can decrease complexity and certain costs, and make prototyping easier. A system with a higher number of nozzles can increase throughput. FIG. 15 depicts staggered cell dispense elements for higher density multiwell plates (1520). At 1510, another single-cell dispensehead variant is illustrated. In some examples, a microfluidic system may include a set of dispense heads, each dispense head having a first dispenser to dispense a first biological cell type and a second dispenser to dispense a second biological cell type, a first dispenser channel to load cells into a first cell staging chamber ready to be dispensed by the first dispenser, and a second dispenser channel to load cells into a second cell staging chamber ready to be dispensed by the second dispenser. The set of dispense heads may include one or more additional dispensers (e.g., a third dispenser and a fourth dispenser) for dispensing one or more reagents via one or more channels or openings. Sensing circuits may be included to detect single cells in the first dispenser channel and the second dispenser channel to enable one cell at a time to be dispensed by the first dispenser and the second dispenser, respectively. The set of dispense heads may have a staggered arrangement in which each dispense head in a first subset of the set of dispense heads extends farther out than each dispense head in a second subset of the set of dispense heads.

The disclosed approach and the example implementations discussed herein enable higher target cell utilization, as target cells are strictly paired with sensor cells, not indiscriminately paired. Where target cells are B-cells, for example, there is a high probability of more clinically relevant B-cell hits relative to antibody—antigen binding screening. More B-cells are selected per B-cell input, producing a larger variety of monoclonal antibodies to select from, which can result in finding an antibody with larger specificity and sensitivity. Each target cell can be dispensed into its own well for further characterization and selection.

The disclosure has been described above with reference to the various examples. However, it is to be understood that various modifications may be made in form and detail without departing from the scope of the disclosure as defined by the appended claims and their equivalents.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An example storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

As utilized herein, the terms “approximately,” “about,” “substantially”, and similar terms are intended to have a broad meaning in harmony with the common and accepted usage by those of ordinary skill in the art to which the subject matter of this disclosure pertains. These terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

It should be noted that the terms “exemplary,” “example,” “potential,” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” “up,” “down”) may merely be used to describe the orientation of various elements as arranged in the Figures. It should be noted that the orientation of various elements may differ according to other potential embodiments, and that such variations are intended to be encompassed by the present disclosure.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It is important to note that the construction and arrangement of the devices, assemblies, and steps as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

Sample implementations are disclosed below, in order to represent illustrative examples, which may be further modified, combined, constrained, etc. according to the entirety of this disclosure.

Example AA: A microfluidic system comprising: a dispense head comprising: a first dispenser to dispense a first biological cell type and a second dispenser to dispense a second biological cell type; a first dispenser channel to load cells into a first cell staging chamber to be dispensed by the first dispenser, and a second dispenser channel to load cells into a second cell staging chamber to be dispensed by the second dispenser; and one or more sensing circuits to detect single cells in the first dispenser channel and in the second dispenser channel; and a controller to use the dispense head to dispense, in each individual well of a multiwell plate, an individual first cell from the first cell staging chamber and an individual second cell from the second dispenser cell staging chamber such that the individual first cell and the individual second cell interact in the individual well.

Example AB: Example AA, the controller further moving the multiwell plate to a cell incubator after dispensing cells into the individual wells of the multiwell plate.

Example AC: Example AB, the controller further moving the multiwell plate to a plate reader after moving the multiwell plate to the cell incubator.

Example AD: Any of Examples AA to AC, further comprising a stage that is movable by the controller, the stage holding the multiwell plate.

Example AE: Any of Examples AA to AD, further comprising a plate reader to detect signals from the individual wells of the multiwell plate a predetermined time after dispensing cells into the multiwell plate.

Example AF: Any of Examples AA to AE, the controller further to identify one of the individual wells in the multiwell plate for holding cells exhibiting a characteristic, and dispensing contents of the identified individual well into a multiwell receiver plate.

Example AG: Example AF, wherein the controller uses a well plate dispensing element to dispense the contents of the identified individual well into the multiwell receiver plate, the well plate dispensing element comprising at least one of a laser, an air jet nozzle, or a surfactant dispenser.

Example AH: Any of Examples AA to AG, further comprising a third dispenser to dispense a reagent into the individual wells of the multiwell plate.

Example AI: Any of Examples AA to AH, further comprising a liquid handling robot to move the multiwell plate after cells are dispensed into the individual wells.

Example AJ: Example AI, wherein the liquid handling robot moves the multiwell plate to at least one of a cell incubator or a plate reader.

Example BA: A method comprising: using a dispense head to dispense, in each individual well of a multiwell plate, an individual first cell from a first cell staging chamber and an individual second cell from a second dispenser cell staging chamber such that the individual first cell and the individual second cell interact in the individual well, the dispense head comprising: a first dispenser to dispense a first biological cell type and a second dispenser to dispense a second biological cell type; a first dispenser channel to load cells into the first cell staging chamber to be dispensed by the first dispenser, and a second dispenser channel to load cells into the second cell staging chamber to be dispensed by the second dispenser; and one or more sensing circuits to detect single cells in the first dispenser channel and in the second dispenser channel.

Example BB: Example BA, further comprising selecting, from among a plurality of individual wells of the multiwell plate, one of the plurality of individual wells for holding a biological cell exhibiting a characteristic.

Example BC: Example BB, further comprising isolating a cell of the first biological type in the selected individual well and performing a production or characterization step on the isolated cell.

Example BD: Example BB or BC, wherein the characteristic is indicative of a B-cell producing an antibody having an effect on a corresponding sensor cell in the selected individual well.

Example BE: Any of Examples BB to BD, further comprising using a well plate dispensing element to dispense contents of the selected individual well into a multiwell receiver plate, the well plate dispensing element comprising at least one of a laser, an air jet nozzle, or a surfactant dispenser.

Example BF: Any of Examples BA to BE, wherein the first cell of the first biological type is a B-cell, and the second cell of the second biological type is a sensor cell with a druggable pathway of interest.

Example BG: Any of Examples BA to BF, further comprising using a third dispenser to dispense a reagent into the individual wells of the multiwell plate.

Example BH: Any of Examples BA to BG, further comprising moving the multiwell plate to a cell incubator after dispensing cells into the individual wells of the multiwell plate.

Example BI: Any of Examples BA to BH, further comprising moving the multiwell plate to a plate reader after dispensing cells into the individual wells of the multiwell plate.

Example BJ: Any of Examples BA to BI, further comprising using a plate reader to detect a signal from the individual wells of the multiwell plate to determine whether one or more of the individual wells contain cells undergoing a desired interaction.

Example CA: A microfluidic system comprising: a set of dispense heads, each dispense head comprising: a first dispenser to dispense a first biological cell type and a second dispenser to dispense a second biological cell type; a first dispenser channel to load cells into a first cell staging chamber ready to be dispensed by the first dispenser, and a second dispenser channel to load cells into a second cell staging chamber ready to be dispensed by the second dispenser; and one or more sensing circuits to detect single cells in the first dispenser channel and the second dispenser channel to enable one cell at a time to be dispensed by the first dispenser and the second dispenser, respectively; wherein the set of dispense heads have a staggered arrangement in which each dispense head in a first subset of the set of dispense heads extends farther out than each dispense head in a second subset of the set of dispense heads.

What is claimed:

1. A microfluidic system comprising:
a dispense head comprising:
a first dispenser to dispense a first biological cell type and a second dispenser to dispense a second biological cell type;
a first dispenser channel to load cells into a first cell staging chamber to be dispensed by the first dispenser, and a second dispenser channel to load cells into a second cell staging chamber to be dispensed by the second dispenser; and
one or more sensing circuits to detect single cells in the first dispenser channel and in the second dispenser channel; and
a controller to use the dispense head to dispense, in each individual well of a multiwell plate, an individual first cell from the first cell staging chamber and an individual second cell from the second dispenser cell staging chamber.

2. The microfluidic system of claim 1, the controller further moving the multiwell plate to a cell incubator after dispensing cells into the individual wells of the multiwell plate.

3. The microfluidic system of claim 2, the controller further moving the multiwell plate to a plate reader after moving the multiwell plate to the cell incubator.

4. The microfluidic system of claim 1, further comprising a stage that is movable by the controller, the stage holding the multiwell plate.

5. The microfluidic system of claim 1, further comprising a plate reader to detect signals from the individual wells of the multiwell plate a predetermined time after dispensing cells into the multiwell plate.

6. The microfluidic system of claim 1, the controller further to identify one of the individual wells in the multiwell plate for holding cells exhibiting a characteristic, and dispensing contents of the identified individual well into a multiwell receiver plate.

7. The microfluidic system of claim 6, wherein the controller uses a well plate dispensing element to dispense the contents of the identified individual well into the multiwell receiver plate, the well plate dispensing element comprising at least one of a laser, an air jet nozzle, or a surfactant dispenser.

8. The microfluidic system of claim 1, further comprising a third dispenser to dispense a reagent into the individual wells of the multiwell plate.

9. The microfluidic system of claim 1, further comprising a liquid handling robot to move the multiwell plate after cells are dispensed into the individual wells.

10. The microfluidic system of claim 9, wherein the liquid handling robot moves the multiwell plate to at least one of a cell incubator or a plate reader.

11. A method comprising:
using a dispense head to dispense, in each individual well of a multiwell plate, an individual first cell from a first cell staging chamber and an individual second cell from a second dispenser cell staging chamber such that the individual first cell and the individual second cell interact in the individual well, the dispense head comprising:
a first dispenser to dispense a first biological cell type and a second dispenser to dispense a second biological cell type;
a first dispenser channel to load cells into the first cell staging chamber to be dispensed by the first dispenser, and a second dispenser channel to load cells into the second cell staging chamber to be dispensed by the second dispenser; and
one or more sensing circuits to detect single cells in the first dispenser channel and in the second dispenser channel.

12. The method of claim 11, further comprising selecting, from among a plurality of individual wells of the multiwell plate, one of the plurality of individual wells for holding a biological cell exhibiting a characteristic.

13. The method of claim 12, further comprising isolating a cell of the first biological type in the selected individual well and performing a production or characterization step on the isolated cell.

14. The method of claim 12, wherein the characteristic is indicative of a B-cell producing an antibody having an effect on a corresponding sensor cell in the selected individual well.

15. The method of claim 12, further comprising using a well plate dispensing element to dispense contents of the selected individual well into a multiwell receiver plate, the well plate dispensing element comprising at least one of a laser, an air jet nozzle, or a surfactant dispenser.

16. The method of claim 11, wherein the first cell of the first biological type is a B-cell, and the second cell of the second biological type is a sensor cell with a druggable pathway of interest.

17. The method of claim 11, further comprising using a third dispenser to dispense a reagent into the individual wells of the multiwell plate.

18. The method of claim 11, further comprising moving the multiwell plate to a cell incubator after dispensing cells into the individual wells of the multiwell plate.

19. The method of claim 11, further comprising using a plate reader to detect a signal from the individual wells of the multiwell plate to determine whether one or more of the individual wells contain cells undergoing a desired interaction.

20. A microfluidic system comprising:
a set of dispense heads, each dispense head comprising:
a first dispenser to dispense a first biological cell type and a second dispenser to dispense a second biological cell type;
a first dispenser channel to load cells into a first cell staging chamber ready to be dispensed by the first dispenser, and a second dispenser channel to load cells into a second cell staging chamber ready to be dispensed by the second dispenser; and
one or more sensing circuits to detect single cells in the first dispenser channel and the second dispenser channel to enable one cell at a time to be dispensed by the first dispenser and the second dispenser, respectively;
wherein the set of dispense heads have a staggered arrangement in which each dispense head in a first subset of the set of dispense heads extends farther out than each dispense head in a second subset of the set of dispense heads.
